(19) United States
(12) Patent Application Publication
(10) Pub. No.: US 2024/0056651 A1
(43) Pub. Date: Feb. 15, 2024

(54) DIGITAL RIGHTS MANAGEMENT USING A GATEWAY/SET TOP BOX WITHOUT A SMART CARD

(71) Applicant: DISH NETWORK, L.L.C., Englewood, CO (US)

(72) Inventors: James BRUNNER, Englewood, CO (US); Ross Alan DRENNAN, Englewood, CO (US); Jesus FLORES GUERRA, Englewood, CO (US)

(73) Assignee: DISH NETWORK, L.L.C., Englewood, CO (US)

(21) Appl. No.: 17/884,089

(22) Filed: Aug. 9, 2022

(51) Int. Cl. H04N 21/6334

(52) U.S. Cl. CPC H04N 21/63345

(57) ABSTRACT

A gateway device is disclosed that includes a user key; a transceiver to communicate data over a network and with a set top box; and a processor configured for: receiving a protected secure key from a content provider; receiving an encrypted control word key from the content provider. The encrypted control word key is encrypted with a secure key and, once the encrypted control word key is decrypted, the decrypted control word key decrypts an encrypted digital content that is sent to a set top box; retrieving the user key from the memory of the gateway device; using the user key to decrypt the protected secure key to obtain a decrypted secure key; using the decrypted secure key to decrypt the encrypted control word key to obtain the decrypted control word key; and transmitting the decrypted control word key to the set top box for decrypting the encrypted digital content.

### BACKGROUND

Digital video broadcast (DVB) provides a standard for the distribution of digital broadcast video content. To avoid unauthorized watching of the DVB, the DVB standard includes a mechanism for encrypting the distributed content prior to transmission.

DVB, however, does not dictate a digital rights management (DRM) scheme or key delivery standard. These two elements ensure the secure transmission and conditional access to the protected content. DVB leaves this aspect of content protection to the development of proprietary DRM systems.

In the rights managements system, distributing conditional access to the rights needed to decrypt and use the distributed information can be a challenge. Rights embody what an end user is allowed to do with the encrypted content, for example, play the content for a certain period or copy the content a limited number of times. DRM accomplishes this conditional access to the content by wrapping the keys required to decrypt the content into a tightly controlled system where the rights themselves cannot be freely copied or distributed. The successful control of these rights requires that they be individualized to restrict distribution of the rights beyond a particular authorized end user.

Current DVB DRM solutions provide DRM control utilizing specialized equipment, such as set top boxes with smart cards and modems, to distribute rights vouchers. However, the specialized equipment required to carry out the rights delivery takes up space in the set top box or modem.

### SUMMARY

The above identified problems are solved and a technical advance is achieved by providing systems and methods for using DRM to control conditional access to DVB content. Specifically, some embodiments of this invention relate to securing broadband digital content delivery and rights management using a set top box that does not require specialized hardware to decrypt the DVB. In this regard, for example, a gateway that is always connected to the internet will be able to download the keys required for decrypting the DVB while a satellite transmits the encrypted DVB content.

In this regard, no specialized hardware is needed for the set top box since an only software solution is provided for decryption of the DVB for end use viewing of the DVB.

According to one embodiment, a gateway device is disclosed that includes a user key; a transceiver to communicate data over a network and with a set top box; and a processor configured for: receiving a protected secure key from a content provider; receiving an encrypted control word key from the content provider. The encrypted control word key is encrypted with a secure key and, once the encrypted control word key is decrypted, the decrypted control word key decrypts an encrypted digital content that is sent to a set top box; retrieving the user key from the memory of the gateway device; using the user key to decrypt the protected secure key to obtain a decrypted secure key; using the decrypted secure key to decrypt the encrypted control word key to obtain the decrypted control word key; and transmitting the decrypted control word key to the set top box for decrypting the encrypted digital content.

According to another embodiment, a method for protecting broadcast digital content includes: encrypting digital content with a decrypted control word key; encrypting the decrypted control word key with a secure key; transmitting the encrypted control word key to a gateway device; transmitting the encrypted digital content to a set top box; protecting the secure key with a user key and assigning rights to the protected secure key; and transmitting, via a protected voucher (or certificate/license), the protected secure key and the assigned rights to the gateway device over at least one of a number of networks. In response to the gateway device receiving the protected secure key, the gateway device: retrieves the user key from memory of the gateway device that is pre-stored in the gateway device memory prior to the receiving of the broadcasting; decrypts the protected secure key using the user key to obtain the secure key; decrypts the encrypted control word key using the decrypted secure key to obtain the decrypted control word key; and transmits the decrypted control word key to the set top box for decrypting the encrypted digital content.

According to another embodiment, a method for viewing protected digital content implemented by a set top box, the method includes: receiving encrypted digital content and an encrypted control word key with a receiver of a gateway device; receiving, via a protected voucher, a protected secure key and assigned rights at the gateway device over an internet connection; decrypting the encrypted control word key with the protected secure key in accordance with the assigned rights; decrypting the broadcast of the encrypted digital content with the decrypted control word key; and rendering the digital content

### BRIEF DESCRIPTION OF THE DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIG. 1 illustrates a block diagram showing the delivery of DVB encrypted content, according to some embodiments.

FIG. 2 is a block diagram showing an exemplary embodiment of a DRM system for DVB using a gateway with an internet connection, according to some embodiments.

FIG. 3 is a block diagram of a gateway device, according to some embodiments.

FIG. 4 is a block diagram showing an exemplary embodiment of a DRM system for DVB using a gateway with an internet connection, according to other embodiments.

FIG. 5 is a block diagram showing an exemplary embodiment of the operation of communication between a gateway device and a set top box, according to other embodiments.

FIG. 6 is a block diagram showing an exemplary embodiment of the operation of a method of DRM authentication between various entities, including, a satellite, a content provider, a DRM system, a gateway device and a set top box, according to various embodiments.

Other and further aspects of the invention will become apparent during the course of the following description and by reference to the attached drawings.

### DETAILED DESCRIPTION OF EMBODIMENTS

Broadly speaking, systems and methods, according to some embodiments, provide an efficient and secure method for transmitting DRM rights in a DVB environment. For example, some embodiments allow for a gateway device to obtain required keys or perform authorization of the DVB content without needing a smart card at a set top box to perform such action. This may be done using separate distribution paths to allow transmission and rights control to occur separately and in a protected manner.

Additionally, in a particularly advantageous embodiment the present invention employs the gateway and internet infrastructure and established DRM standards for ready-made billing and content control.

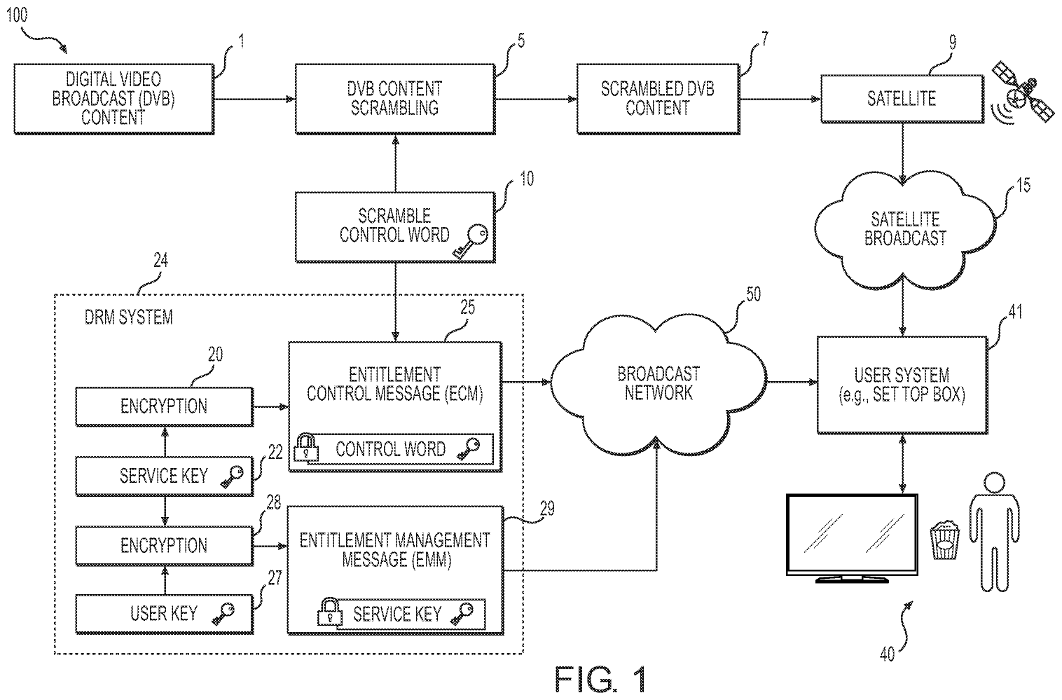

FIG. 1 presents an overview of the DVB content encryption and delivery scheme. Unencrypted DVB content 1 is first encrypted in accordance with a DVB scrambling algorithm (DVB CSA) 5. DVB CSA 5 takes the unencrypted DVB content 1 and a random CSA control word 10 as input. DVB CSA 5 then employs a symmetric encryption algorithm to generate the encrypted DVB content 7. The CSA control word 10 must later be used by a decryption algorithm to decrypt the encrypted DVB content 7 and recover the usable clear DVB content. The CSA control word can, therefore, be thought of as the key to the distributed encrypted content. The encrypted DVB content 7 is now safe to freely broadcast over the airways 50 to DVB end users 40, via a system 41 (e.g., TVs, tuners, a set top box, etc.).

With regard to the end users, the figures only show one symbol to designate end users 40, however, it should be understood that any number of end users might receive the broadcasted content. In addition, the system 41 represents a number of hardware and software structures that perform DVB functions, e.g. receiving and decrypting DVB content and messages. The end user system 41 can be embodied by any suitable known equipment, such as TVs, tuners, or set top boxes programmed to operate in accordance with the DVB standard and the disclosed system.

The process described thus far is defined by the DVB standard and therefore should be consistent among various DVB implementations. However, the encrypted DVB content received by the end users 40 will only be useful if it can be decrypted. To do so, the end user 40 will require a copy of the CSA control word 10. A complete DRM system should both protect the secrecy of the control words in transit and limit their use by the end users in accordance with the rights granted by the content providers. A general approach for carrying out this proprietary aspect of the DVB system is shown in the content encryption section illustrated as the dashed rectangle in FIG. 1.

First, the CSA control word 10 is encrypted 20 with a service key (SK 22). The service key 22 is used to encrypt all CSA control words associated with a particular DVB service, e.g. a premium channel or a pay-per-view event. Different services, however, would most likely use different keys. The encrypted CSA control word is added to an entitlement control message (ECM 25). In addition to the encrypted CSA control word, the ECM 20 might also include header information or other relevant data. The ECMs are then transmitted over the broadcast network 50 to the end users 40.

The encrypted CSA control word contained in the ECM 25 must be decrypted before it can, in turn, be used to decrypt the encrypted DVB content. Accordingly, the service key 22 must be transmitted to the end user. To do so securely, the service key is encrypted 28 with a user key (UK 27) that is specific to a particular end user. Typically the UK is stored in a protected smart card in the end users set top box. The encrypted SK is then used to generate an entitlement management message EMM 29. The 29 EMM might also include header or rights information. The transmitted rights information, for example, would dictate how the end user can use the protected content.

Unlike the previous encryption steps, the user key 27 does not need to be transmitted to the end users 40 because the end users' hardware is pre-programmed to decrypt data encrypted with the user key 27 and thus, the user key is already stored at the user system 41. A number of procedures can be employed to ensure the secrecy and usability of the user key 27. For example, the end users' hardware can be pre-programmed with a shared secret known by the DVB system. Or, a public key cryptography system can be employed to encrypt the service key 22 without ever knowing the end users' user key 27. In either instance, upon receipt of EMM the end user's system 41 decrypts the service key 22 which in turn is used to decrypt the CSA control word 10 which ultimately is used to decrypt the broadcast content 7.

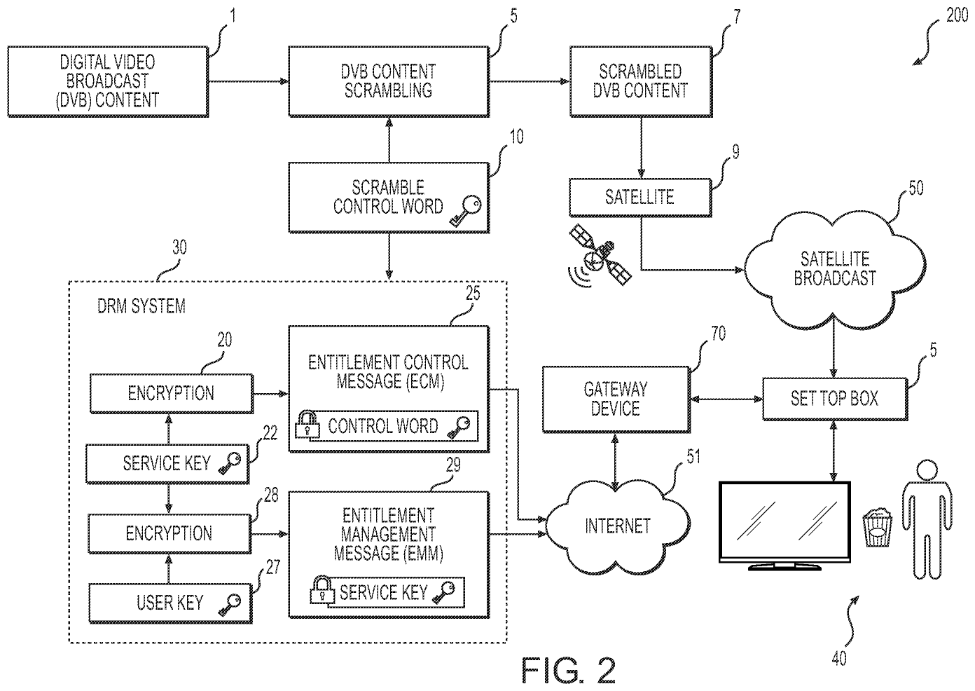

In the example shown in FIG. 1, the system 41 (e.g., set top box) includes a smart card which is specifically programmed with the user key and to dynamically refresh the control word 10 in order to decrypt the scrambled DVB content 7. However, FIG. 2 illustrates an alternate system which takes advantage of a constant internet connection with the gateway device 70 (or another device, which could be any device of the user including the set top box).

As shown in FIG. 2, the general approach for transmission of DVB content is modified to employ a gateway device 70. The delivery of the encrypted DVB content 7 and encrypted control words within ECMs 25 is done as shown in FIG. 1. The introduction of a gateway device 70, however, allows the system of FIG. 2 to off-load DRM implementation and service requirements from the DVB broadcaster to the data network, such as the internet or a cellular network.

The content provider, i.e. the broadcaster, delivers the service key 22 together with other data relating to the content, to the DRM system. In practice this could be accomplished by a server at the content provider generating and sending the service key 22 via any known method of computer to computer communication.

In one embodiment, the service key 22 is sent already encrypted by the user key 27 in an EMM. The DRM system would add the particular formatting and rights information needed and then send the EMM to the gateway device 70.

The broadcaster could provide the DRM System 30 with the service key 22 prior to its encryption with a user key 27. This would limit the amount of data traffic between the DVB broadcaster and the DRM System 30 because the SK is generic to all users, while an encrypted EMM is user specific and must be generated for each end user requesting the service. These two examples demonstrate the fact that the various aspects of the DVB encryption/broadcast and the DRM System can be split up between the DVB and DRM service providers in any number of ways, including a system where the DVB provider also performs the DRM services.

The rights enforcement supplied by the DRM System 30 can be performed with any known DRM technique. For example, the gateway devices participating in the system can be designed from the ground up to include a user key 27 and DRM software and/or hardware that protects the user key 27. The software and/or hardware would ensure that the gateway device only uses the user key 27 in accordance with instructions provided by the DRM system 30. In this embodiment, the DRM system 30 would either need to know the user key 27, i.e. a shared secret, or know how to encrypt content so that the user key 27 can decrypt it, i.e. public key cryptography, such as blockchain.

Returning to the embodiment of FIG. 2, once the DRM System 30 receives the service key 22, it provides DRM protection for the service key 22 and distributes the service key 22 to the end users over a different network, such as the internet. This is possible because the gateway device 70 is always connected to and capable of continuously communicating over the internet.

The DRM System 30 can be embodied by a computer or a group of computers that are programmed to perform the disclosed operations and are connected to the network 51 such that they can transmit data to gateway devices 70.

The DRM System 30 may also have data stored on the user, such as e.g. identification data (name, address, phone number, etc.), data relating to his DRM compliant devices, data relating to content subscription, data relating to billing etc. The DRM System 30 may communicate with the network operator, e.g. for billing purposes.

Thus, in on embodiment, one of the functions of the DRM System 30 is to provide the DRM infrastructure to the gateway device 70.

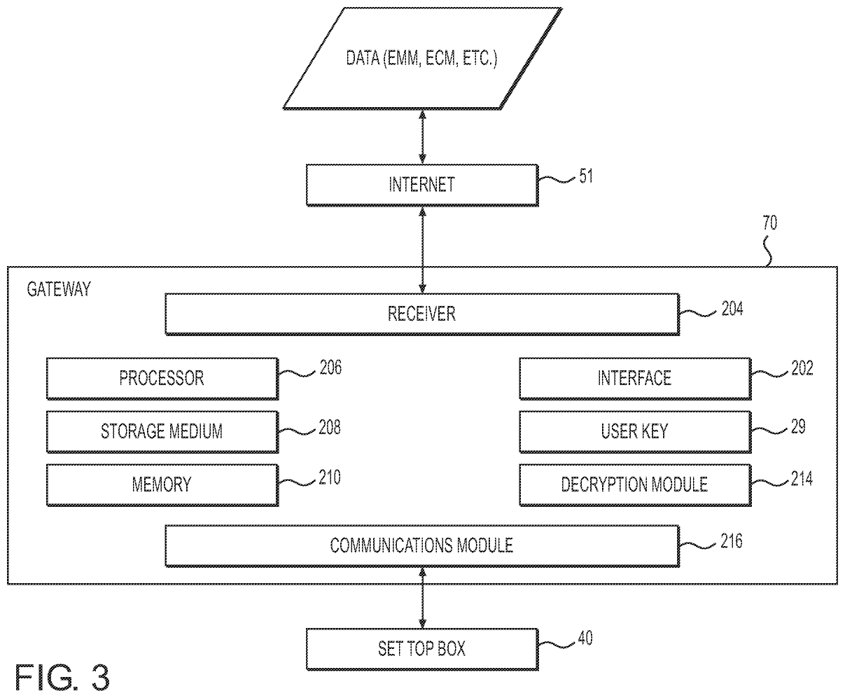

FIG. 3 illustrates an exemplary gateway device 70 that is configured to perform the functions discussed herein.

The gateway device 70 comprises a user interface 202, a receiver 204, a processor 206, storage medium 208, memory 210, a decryption module 214 and a communications module 216. Each of these components is discussed in greater detail below.

The gateway device 70 receives data, such as the EMM, ECM, etc. via the internet 51 at the receiver 204. The receiver 204 is a port on the gateway device 70 that receives data signals from a wired or wireless connection via the internet (or other network). These signals are then processed by the processor 206 and software in the gateway device 70 to effectively decrypt the data and deliver the decrypted data to the set top box 40. In an alternate embodiment, the signals may instead simply be received by the processor 206 and software in the gateway device 70 to effectively provide the data to the set top box 40 for the set top box 40 to perform such decryption. Regardless, because the gateway device 70 has a constant internet connection, the gateway device 70 can get the data for the decryption process in a real time basis.

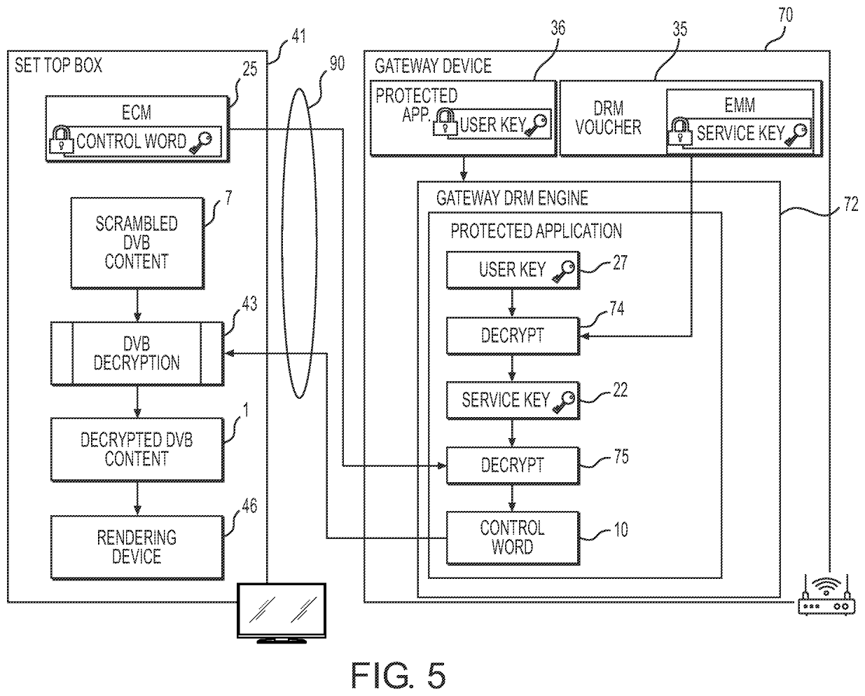

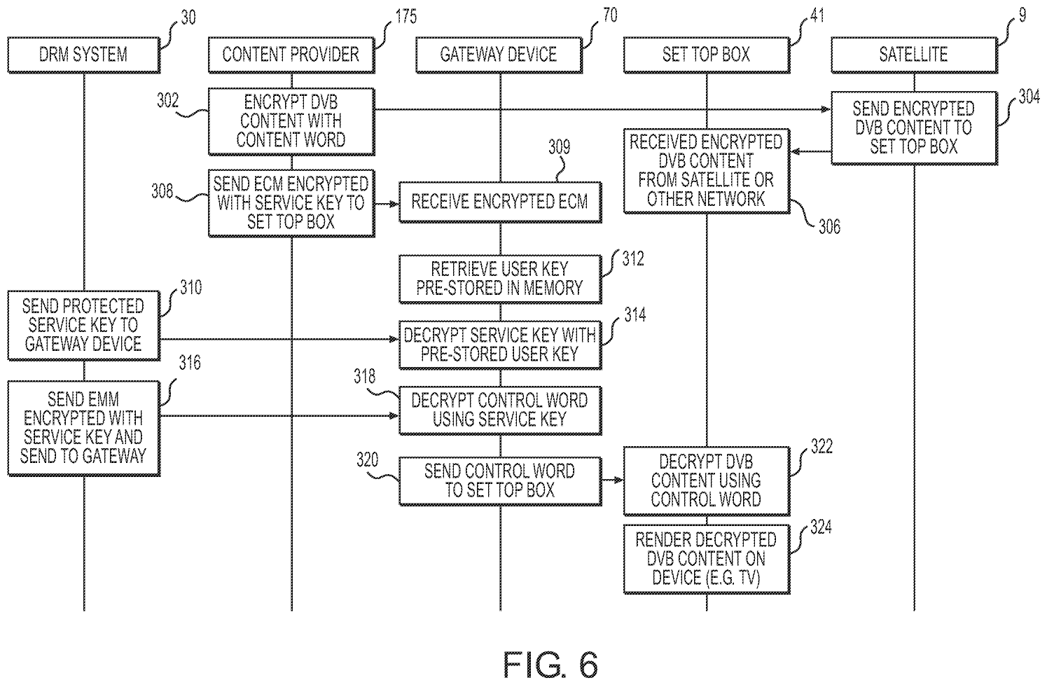

Referring back to FIG. 3, the processor 206 may be a hardware processor (e.g., CPU) that is configured to execute instructions stored in storage medium 208. The processor 206 is configured to interact with each of the modules 211, 29, and 214 and stored data, such as device list 210 and other software and/or data stored in the storage medium 208. For example, the processor 206 is configured to perform at least one or more or all of the steps presented herein, including those shown in FIGS. 5-6.

The memory 210 may be any memory, such as random access memory (RAM) which is configured to allow for temporary storage and for processing data in conjunction with the processor 206.

Any of the modules 214 and 216 (and other software modules or data) may be stored in the storage medium 208 or memory 210. For example, the user key 27 may be stored on the storage medium 208. The storage medium 208 may be any type of temporary or persistent storage device capable of storing instructions and data. The storage medium 208 may be internal and/or external to the gateway device 70 and may include one or more storage devices. In one embodiment, the storage medium 208 is a non-transitory computer readable storage medium having a physical presence configured for long term storage of data. For example, the storage medium 208 may be an internal hard drive or flash memory.

The user key 27 may be the same user key 22 mentioned above and is pre-programed in the gateway device 70 prior to any of the steps provided herein. In this regards, the user key 27 is not transmitted over any network in order for security purposes and may be encrypted in the gateway device 70. The user key 27 may be updated by the processor each time a new data stream is received at the gateway device 70, according to an embodiment, so that no user key 27 is used twice. However, in another embodiment, the user key 27 may be used in every decryption process until there is a security breach, at point, the user key 27 will be updated.

The decryption module 214 performs one or more tasks of the method steps provided herein. For example, the decryption module 214 uses the user key 27 to decrypt the encrypted control word received and/or the encrypted EMM received. Once this is performed, this information is then used to decrypt or descramble the scrambled DVB content 7. This decryption process can occur in the gateway device 70 or in the set top box 5.

The communications module 216 communicates with the decryption module 214 to deliver any information between the gateway device 70 and the set top box 5, such as any ECM messages, EMM messages, decrypted data (e.g., control word), etc. This may be done wirelessly over a secured network or connection or over an unsecured short range network, such as WiFi or Bluetooth, or via a wired connection. Moreover, for any networks that is vulnerable to a MITM (man in the middle) attack, any data used in a transmission over this network could be secured using various methods, such as blockchain validation. In other words, the data transmitted could only be used on a device that is recorded in the blockchain and thereafter records the transaction back to the blockchain.

It should be noted that the gateway device 70 and the set top box 5 may be a single device or separate devices. In this regard, the gateway device 70 may receive the satellite broadcast and communicate over the internet to decrypt the ECM, EMM, and DVB content. As such, because the gateway device 70 would perform the functions of the set top box 5, the gateway device 70 may eliminate the need for a set top box 5 in the user's home.

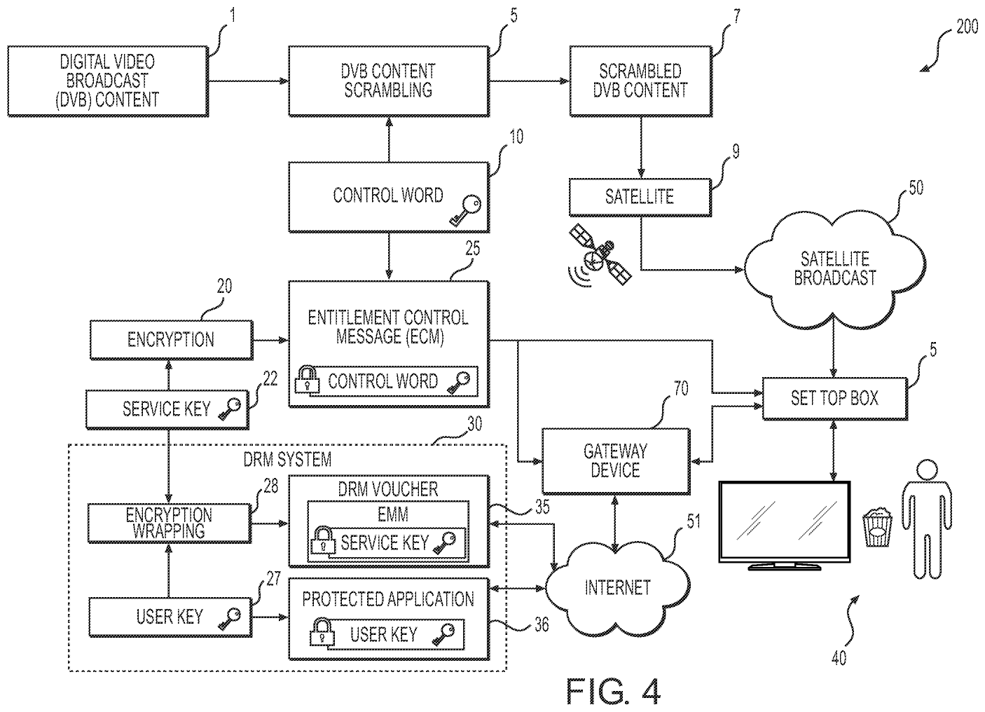

FIG. 4 illustrates another general approach for transmission of DVB content employing a gateway device 70 similar to FIG. 3, but is modified relative to FIG. 3 to split handling of the ECM message and handling of the EMM function, as explained more below.

As mentioned above, the delivery of the encrypted DVB content 7 and encrypted control words within ECMs 25 is done as shown in FIG. 1. The introduction of a gateway device 70, however, allows the system of FIG. 2 to off-load DRM implementation and service requirements from the DVB broadcaster to the data network, such as the internet or a cellular network.

As shown in FIG. 4, the DRM system 30 provides the gateway device 70 with a protected application 36 containing the user key 27. The protected application 36 runs on the gateway device 70 and performs DRM operations, such as, e.g., key decryption and rights enforcement. The protected application 36 can be programmed according to any known methods of providing protected computing. Moreover, once installed in the gateway device 70, the protected application 36 provides DRM enforcement for any number of EMMs sent by the system. This embodiment is particularly advantageous because it provides for the delivery of the user key 27. It can, therefore, both initiate a gateway device that has never participated in the particular DRM system, and refresh the user key 27 on gateway devices in the system to provide updated security.

In addition to providing the protected application 36, the DRM system 30 must also be programmed to provide a protected service key 22, and rights dictating its use, to the gateway device 70. This is accomplished by encrypting/wrapping 34 the service key 22 to create an EMM wrapped in a DRM voucher/certificate/license 35, which dictates the usage rights for the service key 22. Accordingly, the computers embodying the DRM system 30 are programmed to wrap and encrypt 34, i.e. encapsulate, the EMM and other data into a DRM voucher 35. The DRM system 30 communicates with gateway devices through a network (e.g., a LAN, WAN, etc.) to deliver the DRM messages and objects, e.g. DRM voucher and protected applications.

As a rights object, the DRM voucher could also include protected rights definitions dictating the number and type of uses that can be performed on the content associated with the service key 22. The DRM voucher may further comprise other data, e.g. data relating to the requested/ordered content and data relating to the billing or payment. The DRM voucher may be expressed in a rights expression language, such as e.g. ODRL, or in an extensible markup language such as e.g. XML, or in any derivatives thereof.

The function of the rights object, however, could be implemented in a less flexible way by pre-programming the rights into the system or the protected application. For example, the protected application could be programmed to only allow a certain set of rights, e.g. one play, for all EMMs it receives.

Turning now to the operation of the gateway device 70 and the operations performed at the end user 40. As noted above, the end user 40 employs a means of receiving DVB encrypted content and providing output via a display. In the disclosed embodiment, this operation is performed by a DVB set top box; however, the disclosed operations can be integrated into a TV or can be embodied by any hardware known in the art capable of performing the disclosed functions, including the gateway device 70, as mentioned above.

As shown in FIG. 5, the set top box 41 communicates with the gateway device over any known communication link, such as a wired connection or a wireless RF or infra-red link. One embodiment would employ Bluetooth for the communications between the set top box 41 and the gateway device 70 because it is an established standard and provides a ready-made secure connection between the set top box 41 and the gateway device 70. As previously discussed, the gateway device 70 is a hardware device connected to the network (e.g., internet) and programmed to perform the disclosed functions of the DRM system.

The method shown in FIG. 5 begins with the end user 40 ordering protected DRM content. Lists of available content can be set up for browsing on the television via the DVB network or set top box or the gateway device itself via one or more user interfaces. In the case where the user browses for content on the gateway device 70, the gateway device 70 can connect to servers at the DRM system 30, or from other sources, to receive data describing the available content choices. Alternately, the available content can be browsed and ordered via other networks, e.g., cellular networks of a mobile device.

In any case, once the user has selected a particular piece of content, the DRM system 30 is notified and begins to push the required DRM vouchers 35 and software to the gateway device 70. The use of the gateway device 70 in the ordering process enables the DVB content provider 175 to make use of the gateway device billing network to charge for the content. In other words, if a user orders a pay per view movie the charge for that movie can be simply added to the user's bill associated with the services subscribed to by the user (e.g., internet bill, TV bill, etc.). The gateway device 70 may be a device for connecting the user 40 to the internet, a TV provider device, etc.

With the content ordered, the process of using the content beings. As shown in FIG. 5, the set top box 41 receives, or has previously received and stored, the encrypted DVB content 7 and it's associated ECMs 25. The set-top box, however, cannot use any of the encrypted DVB content 7 without the control word 75 contained in the ECM 25. However, the ECM 25 must be decrypted with the appropriate service key 22 to obtain the clear (i.e., unencrypted) control word. To do this, the set top box 41 passes the ECM 25 to the gateway device 70 over the communications link 90 (e.g., Bluetooth link). The communications link 90 does not necessarily need to be protected at this stage because the ECM 25 contains an encrypted control word. Advantageously, many set top boxes 41 may perform a similar function and send the received ECMs 25 to a smart card for decryption. However, in this embodiment, the set top boxes need only to communicate with the gateway device instead of a smart card since the gateway device 70 is always connected to the internet to receive communications and perform the authorization process discussed herein.

As described above, and shown in FIG. 5, the gateway device 70 has received the protected application 36 and the DRM voucher 35 from DRM System 30. The process for decrypting the encrypted control word is, as follows, preferably the gateway device has a Mobile DRM engine 72, which is hardware and/or software designed to perform secure processing and is resistant to tampering by individuals attempting to thwart the applied DRM. The DRM engine 72 runs the protected application 36, which has secure access to the user key 27. The protected application 36 takes the DRM voucher 35 and ECM 25 as input.

The DRM system 30 will then determine if the rights expressed in the DRM voucher 35 allow the requested use, e.g. playing of DVB content. If the requested use is allowed, the protected application uses the user key 27 to decrypt 74 the service key 22 contained in the EMM. The decrypted service key 22 is then used to decrypt the control word contained in the ECM 25 to produce a clear CSA control word 10. The clear CSA control word 10 is then sent back over the communications link 90 to the set top box 41. In one embodiment, the transmission of the clear, i.e. unencrypted, CSA control word 10 to the set top box occurs over a secure Bluetooth link or other link which is not accessible to the public or a potential hacker. Bluetooth link secure connections provide ready-made authentication, authorization, and encryption (ciphering of plain text).

Distributing the protected application to practice the DRM system 30 is particularly advantageous because the protected application can be tailored for the end user's specific gateway device 70 and/or set top box 41 thereby ensuring compatible operation for users regardless of the equipment employed.

Upon receipt of the decrypted CSA control word 10 the DVB set top box 41 uses the CSA control word 10 to perform the DVB decryption process, as shown in process 43. This generates clear DVB content 1 that can then be output to display of a rendering device 46 (e.g., TV, speakers, etc.) for use. Rendering device 46 is merely a generic representation for use of the content. In practice the content could be music, software, etc., which would each be used on an appropriate device. As such, the content referred to herein can be video, music, a combination thereof, download of data, streaming content, or any other type of data that a user can receive/enjoy. Thus, the present invention should not be limited to only playing video content.

In alternative embodiments, the protected application may have a period of validity as expressed in DRM voucher 35 and the protected application may be made inoperable after the validity expires or the protected application may even be discarded, overwritten or deleted wholly or in part. In one embodiment, the protected application 36 that has been made inoperable may be re-activated with a response message from the DRM system 30, where the re-activation message may be a DRM Voucher comprising another protected application.

Other embodiments could use the network or internet 51 to receive location information from such network/internet 51. The location of the gateway device 70 can be determined. The received location information may be used as part of the access control. For example, the DRM voucher might contain geographic restrictions that can be applied using this feature.

Another advantageous embodiment would use the gateway device in connection with any nearby device that receives DVB content. If a Bluetooth connection is used, the Bluetooth Service Discovery Protocol and Bluetooth pairing mechanism will provide a trust relationship that may be used for the necessary set top box identification. This functionality would allow a user to buy and use content at a friend's house or other location.

In some embodiments, a mobile device (e.g., a cellular phone, tablet, computer, etc.) can be used instead of a gateway device herein since such devices can always be connected to the internet and also be communicatively connected to the rendering device 46. In this regard, the present invention should not be limited to only use of a gateway device 70.

In one embodiment, the gateway device 70 and a cellular phone can work together so that one of the devices can perform one or more of the steps in the process discussed herein while the other device perform the other functions. For example, a mobile phone could perform the steps of receiving the DRM voucher and protected application and sending those to the gateway or set top box, or processing those items to produce the control word to provide to the set top box.

In this embodiment, the DRM system can leverage the use of mobile devices and implement the Open Mobile Alliance's (OMA) standard DRM infrastructure. The benefits of using OMA compliant mobile devices to deliver EMNIs and DRM rights are thus two fold. First, mobile phones are a common piece of hardware owned by most individuals; therefore, the broadcaster can provide added services without deploying specialized hardware to all potential end users. Second, the use of mobile phones also allows broadcasters to adopt standard mobile DRM systems like OMA thereby obviating the need to develop and maintain costly specialized systems. Both of these advantages lead to a system where an end user can employ standard equipment to obtain premium DVB content at the spur of the moment. This allows for a more marketable system compared to a system where users must plan ahead and obtain special equipment to view premium content.

In general, OMA defines a software and hardware standard for mobile phones. The OMA DRM standard allows compliant devices to implement and participate in a rights management system, including securely transmitting protected content and an executable application, such as a Java applet. The OMA compliant mobile phone will then run the application, which contains the required user key 27 and other security procedures necessary to ensure the protection of the protected content. In one embodiment, the protected content is simply the service key 22 and the CSA control word 10 rather than the actual usable media.

In the context of some embodiments, the DRM system would create protected applications and DRM vouchers in accordance with the OMA standard. And the gateway device would be designed and programmed to follow the OMA standard when running the OMA application and following the DRM vouchers.

In other embodiments, for added security, the authorization and content word can be accessed using blockchains. In this regard, in order to obtain the control word, the blockchain would be accessed, the transaction would have to be validated and then, if validated, the blockchain would be added to. However, if the blockchain is not validated, this is an indication of a hacker, and the control word will not be provided. Blockchain technology thus can be an advantageous security feature since smart cards are secure due to their hardware and removing such smart cards would require an added layer of security to replace the security being given up without smart cards.

As stated above, the disclosed invention can be embodied in any hardware capable of performing the disclosed operations. For example, in another embodiment all the end user functions of the disclosed invention can be embodied in a single gateway device with a receiving hardware device, a rendering hardware device and a memory device containing a software program to practice the disclosed procedures, such as, e.g., a mobile phone, laptop or personal digital assistant.

Using a gateway device to render broadcast content, however, presents some additional issues that require solutions. One of the most prominent concerns for any gateway device is available bandwidth. Receiving broadcast content may be bandwidth intensive because the gateway device's receiving circuits must stay active during the entire broadcast. For example, the bandwidth required for receiving the broadcast of a movie or television show might significantly reduce the bandwidth of the gateway device 70.

An exemplary embodiment of present invention provides a solution to reduce bandwidth use in broadcast situations. The solution involves providing broadcasts to gateway devices in time sliced and time compressed segments. In other words, if the broadcast link has sufficient bandwidth to send a segment of the broadcast content in less time than it would take to render the content contained in the segment, bandwidth can be saved because the content can be sent and then the receiver can be turned off while the content plays. For example, if a network can broadcast content at 3 megabits per second and the content renders at 300 kilobits per second, the receiver at the gateway device only needs to turn on for a second to receive ten seconds worth of content. The receiver can then turn off for 9 seconds while the content renders, thereby, reducing the power consumption by 90%. The broadcast of live content under this technique would require a slight transmission delay consistent with the employed segment length. For example, if the broadcaster chose to send the content in one minute segments it would have to buffer one minute's worth of content before beginning the transmission of the first segment. Accordingly, the broadcast would be delayed by about a minute.

To carry out the described technique, the gateway device can be provided with a memory device having executable software for performing the disclosed operations. For the disclosed technique to be successful, the gateway device must be provided with the proper timing to turn off and turn on its receiver during segment receipt. The initial determination to turn the receiver on can be generated from a number of sources; typically it will be at the request of the device user for a particular piece of content. The device can then turn off after receiving the first segment. Once off, then next determination is when to turn the receiver back on, which can be accomplished in a number of ways. For example, the segment transmission gap could be preset system wide as part of the protocol employed. In other words, all transmission segments could occur at predetermined intervals. Alternately, the gateway device could automatically turn on its receiver when the current segment is about finish it's rendering phase and wait for the next segment, e.g., when the currently rendering segment reaches 95% completion the receiver can turn on. Alternately, each segment could include data indicating when the next segment will be broadcast. Identifying the broadcast time of the next segment through data in the previous segment, is particularly advantageous because it allows variable segment size and the determination of the timing of the next segment without rendering the current segment.

Referring now to FIG. 6, a method is provided that is similar to FIG. 5 but illustrates which entities perform which tasks. As mentioned above, the gateway 70 and set top box 41 may perform any of the tasks shown in 306, 309, 312, 314, 318, 320, 322, and/or 324.

In block 302, the DVB content is encrypted with the content word 10 by the content provider 175. The content provider 175 can be any number of entities, including the owner of the content, a licensee of the content, etc. For example, the content provider 175 could be a television provider that receives subscriptions from the end users 40. The content provider 175 is in charge of content distribution to the end users and coordinating keys and licenses from owners of the content.

Once the DVB content is encrypted, it may be sent to the end users 40 via a satellite transmission, as shown in block 304. Users 40 can sign up for receiving media content (e.g., TV programming/content, music, etc.) and receive such media using a satellite dish. Alternatively, the present invention is not limited to receiving the content via a satellite and instead this could simply be received over the internet (such as over network 51), over phone lines, over cable lines (via cable providers), etc. The present application simply shows a satellite 9 for ease of illustration using a one embodiment.

In block 306, the encrypted DVB content is received from the satellite 9 (or other network). In block 308, the control word is encrypted with the service key 22, as previously discussed herein, to generate the ECM and such ECM is sent by the content provider 175 to the gateway device 70.

The gateway device 70 receives the ECM (block 309), which may trigger accessing the user key 27 that is pre-stored at the gateway device (and it is not transmitted over a network, in one embodiment, for security purposes), as shown at block 312.

The DRM system 30 sends a protected service key to the gateway device 70, in block 310, as has been discussed herein. The DRM system 30 may reside at different locations, such as at the content distribution provider, at a third party platform, or any other entity which is configured to be able to communication with the gateway device 70 and/or set top box 41.

In block 314, the ECM 25 is decrypted using the user key 27 to obtain the service key 22. Also, the EMM 35 is sent by the DRM system 30 to the gateway device 70, in block 316, and then the service key 22 that was obtained in block 314 is used to decrypt the EMM 35 (block 318), thereby allowing the gateway device 70 to determine the control word 10.

Once the control word 10 is obtained, it is sent the set top box 41 from the gateway device 70, as shown in block 320. In block 322, the control word 10 is then used by the set top box 41 to decrypt the encrypted DVB content 7 using the control word, thereby obtaining unscrambled or decrypted DVB content. Such unscrambled or decrypted DVB content can then be rendered on a rendering device 46, such as a TV by the set top box 41.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a radio access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

What is claimed is:

1. A method for protecting broadcast digital content comprising:
encrypting digital content with a control word key;
encrypting the control word key with a secure key;
transmitting the encrypted control word key to a gateway device;
transmitting the encrypted digital content to a set top box;
protecting the secure key with a user key and assigning rights to the protected secure key; and
transmitting, via a protected voucher, the protected secure key and the assigned rights to the gateway device over at least one of a number of networks;
wherein, in response to the gateway device receiving the protected secure key, the gateway device:
retrieves the user key from memory of the gateway device that is dynamically generated in the gateway device memory prior to the receiving of the broadcasting;
decrypts the protected secure key using the user key to obtain the secure key;
decrypts the encrypted control word key using the decrypted secure key to obtain the decrypted control word key; and
transmits the decrypted control word key to the set top box for decrypting the encrypted digital content.

2. The method of claim 1 wherein the transmitting the protected secure key and the assigned rights occurs over an internet connection with the gateway device, while the broadcasting the encrypted digital content to a set top box occurs over a satellite connection with a satellite.

3. The method of claim 1, wherein the set top box is devoid of a smart card that stores the user key in hardware on the smart card.

4. The method of claim 1, wherein the decrypted control word key is verified using a blockchain transaction.

5. The method of claim 1, further comprising:
generating the user key on a periodic basis, wherein the user key generated corresponds to the user key used by the server encrypt the secure key.

6. The method of claim 5, wherein the user key is generated at one of the gateway device or set top box dynamically using a predefined algorithm.

7. The method of claim 6, wherein the user key is generated at the server using the predefined algorithm prior to transmission of the encrypted digital content.

8. A method for viewing protected digital content implemented by a set top box, the method comprising:
receiving encrypted digital content and an encrypted control word key via a receiver of a gateway device;
receiving, via a protected voucher, an encrypted control word key and assigned rights at the gateway device over an internet connection;
decrypting the encrypted control word key with a protected secure key stored in the set top box accordance with the assigned rights;
decrypting the broadcast of the encrypted digital content with the decrypted control word key; and
rendering the digital content.

9. The method of claim 8 wherein the receiving the protected secure key and the assigned rights occurs over an internet connection with the gateway device, while the broadcast the encrypted digital content to a set top box occurs over a satellite connection with a satellite.

10. The method of claim 8, wherein the set top box is devoid of a smart card that stores the user key in hardware on the smart card and includes a software module to dynamically generate a second control word key.

11. The method of claim 8, wherein the user key is generated at the server using the predefined algorithm prior to transmission of the encrypted digital content.

12. The method of claim 8, further comprising:
generating the user key on a periodic basis, wherein the user key generated corresponds to the user key used by the server encrypt the secure key.

13. The method of claim 12, wherein the user key is generated at one of the gateway device or set top box dynamically using a predefined algorithm.

14. The method of claim 13, wherein the decrypted control word key is generated at a server using the predefined algorithm prior to transmission.

15. A gateway device comprising:
memory storing a user key;
a transceiver configured to communicate data over a network and configured to communicate with a set top box;
a processor configured for:
receiving a protected secure key from a content provider;
receiving an encrypted control word key from the content provider, the encrypted control word key being encrypted with a secure key and, once the encrypted control word key is decrypted to a decrypted control word key, the decrypted control word key is configured to decrypt an encrypted digital content that is sent to a set top box;
retrieving the user key from the memory of the gateway device;
using the user key to decrypt the protected secure key to obtain a decrypted secure key;
using the decrypted secure key to decrypt the encrypted control word key to obtain the decrypted control word key; and
transmitting the decrypted control word key to the set top box for decrypting the encrypted digital content.

16. The gateway device of claim 15 wherein the receiving the protected secure key and the assigned rights occurs over an internet connection with the gateway device, while the broadcasting the encrypted digital content to a set top box occurs over a satellite connection with a satellite.

17. The gateway device of claim 15, wherein the set top box is devoid of a smart card that stores the user key in hardware on the smart card.

18. The gateway device of claim 15, wherein the decrypted control word key is verified using a blockchain transaction.

19. The gateway device of claim 15, further comprising:
generating the user key on a periodic basis, wherein the user key generated corresponds to the user key used by the server encrypt the secure key.

20. The gateway device of claim 19, wherein the user key is generated at one of the gateway device or set top box dynamically using a predefined algorithm, and wherein the user key is generated at the server using the predefined algorithm prior to transmission of the encrypted digital content.
